(19) United States
(12) Patent Application Publication
(10) Pub. No.: US 2024/0209881 A1
(43) Pub. Date: Jun. 27, 2024

(54) FASTENING STRUCTURE

(71) Applicant: DTECH PRECISION INDUSTRIES CO., LTD., New Taipei City (TW)

(72) Inventor: TING-JUI WANG, New Taipei City (TW)

(21) Appl. No.: 18/496,948

(22) Filed: Oct. 30, 2023

(30) Foreign Application Priority Data
Dec. 22, 2022 (TW) 111149371

(51) Int. Cl. F16B 4/00

(52) U.S. Cl. CPC F16B 4/004

(57) ABSTRACT

A fastening structure applicable to a first object and a second object disposed on the first object. The fastening structure includes an anti-rotation segment, a joining segment and a fastening segment. Therefore, the fastening structure is effective in firmly fitting at least two objects together.

### CROSS-REFERENCE TO RELATED APPLICATION

This non-provisional application claims priority under 35 U.S.C. § 119(a) on Patent Application No(s). 111149371 filed in Taiwan, R.O.C. on Dec. 22, 2022, the entire contents of which are hereby incorporated by reference.

### BACKGROUND OF THE INVENTION

### 1. Field of the Invention

The present disclosure relates to fastening structures, and in particular to a fastening structure for firmly fitting at least two objects together.

### 2. Description of the Related Art

Conventionally, fitting at least two objects together is usually carried out with a fastener. However, the fastening of the objects fitted together tends to be unreliable and easily loosens because of the structural design of the fastener.

### BRIEF SUMMARY OF THE INVENTION

In view of the aforesaid drawbacks of the prior art, it is an objective of the present disclosure to provide a fastening structure for firmly fitting at least two objects together.

To achieve the above and other objectives, the present disclosure provides a fastening structure, applicable to a first object, the fastening structure comprising an anti-rotation segment and a joining segment. The anti-rotation segment prevents the fastening structure from rotating relative to the first object. The joining segment is fitted to the first object. The joining segment is a fastening segment, a riveting portion, an expanded connection portion, a soldering portion, a welding portion, a locking portion, or a resilient fastener segment.

The present disclosure further provides a fastening structure applicable to a first object and a second object disposed on the first object, the fastening structure comprising a fastening segment, a directional restriction segment and an anti-rotation segment. The fastening segment is snap-engaged with the second object. The directional restriction segment is connected to the fastening segment and adapted to limit the movement direction of the second object snap-engaged with the fastening segment. The anti-rotation segment prevents the fastening structure from rotating relative to the first object.

In an embodiment of the fastening structure, the fastening segment is snap-engaged with a second object, and the directional restriction segment is connected to the fastening segment and adapted to limit the movement direction of the second object snap-engaged with the fastening segment.

In an embodiment of the fastening structure, the anti-rotation segment and the first object prevent each other from rotating, allowing the anti-rotation segment to be expandedly connected to the first object by an expanded connection portion.

In an embodiment of the fastening structure, the fastening structure has another fastener body, and the another fastener body has an fastening body anti-rotation segment, allowing the fastener body anti-rotation segment and the fastening structure to constrain each other or prevent each other from rotating.

In an embodiment of the fastening structure, the fastening structure has another fastener body, and the another fastener body has another anti-rotation segment, allowing the another anti-rotation segment and another object to constrain each other or prevent each other from rotating.

In an embodiment the fastening structure further comprises a joining segment functioning as the fastening segment, or the fastening structure has a handle segment, or the fastening structure has a wheel component, or the fastening structure has a assisting component, or the fastening structure has another fastener body, or the fastening structure has another fastening structure with a rotational body, or the joining segment is a fastening segment.

In an embodiment of the fastening structure, the directional restriction segment limits an angle between a movement direction of the second object and a joining segment such that the movement direction of the second object is parallel to, perpendicular to, or neither parallel nor perpendicular to the joining segment.

In an embodiment, the fastening structure further comprises a body segment, with the joining segment disposed at the body segment, allowing the anti-rotation segment to be disposed at the joining segment or the body segment.

In an embodiment of the fastening structure, the joining segment has a pressing segment, a material holding space and a restriction segment, with the pressing segment adapted to press the first object such that a material of the first object flows into or enters the material holding space, so as for the restriction segment to confine the fastening structure to the first object, allowing the anti-rotation segment to limit the limiting direction of the fastening structure.

In an embodiment of the fastening structure, the first object has a corresponding stopper component, allowing a compression gap to be formed between the corresponding stopper component and the anti-rotation segment.

In an embodiment of the fastening structure, the fastening structure further comprises a fastener segment with a neck segment, and the neck segment has a limiting segment for limiting the engagement direction of a corresponding limiting segment of a snap-engagement object.

In an embodiment of the fastening structure, the fastening structure further comprises a fastener segment with a limiting segment for limiting the engagement direction of a corresponding limiting segment of a snap-engagement object. Alternatively, the fastening structure may encompass a fastener segment, which features a neck to constrain one pair of fasteners, or it may include a fastener segment designed to limit or restrict one pair of fasteners.

In an embodiment of the fastening structure, the fastening structure further comprises a fastener segment movably disposed at the body segment.

In an embodiment of the fastening structure, the anti-rotation segment and a corresponding stopper component of a mold correspond in position to each other to stop each other, allowing the anti-rotation segment to limit the direction of the fastening structure.

In an embodiment the fastening structure further comprises a fastener segment, with the anti-rotation segment positioned at the fastener segment, so the anti-rotation segment limits the rotation prevention direction or engagement direction of a corresponding anti-rotation component of a snap-engagement object.

In an embodiment of the fastening structure, the anti-rotation segment is a flat surface portion, step portion, knurled portion, inclined surface portion, dented portion, raised portion, arcuate surface, or curved surface.

The fastening structure further comprises a baffle and a shaft segment, with the shaft segment disposed at the joining segment, and the baffle disposed at the shaft segment and adapted to block or guide a fluid.

In an embodiment of the fastening structure, the baffle is movably disposed at the shaft segment.

In an embodiment of the fastening structure, the baffle is sheet-shaped and fanlike.

In an embodiment of the fastening structure, the joining segment has a tin layer curable when cooled down after being heated up and capable of allowing the fastening structure to be soldered or welded to the first object.

In an embodiment of the fastening structure, the shaft segment has a limiting segment, and the baffle has a corresponding limiting segment, allowing the limiting segment and the corresponding limiting segment to jointly limit the direction or angle of the baffle.

In an embodiment of the fastening structure, the shaft segment has a fixing segment, and the joining segment has a corresponding fixing segment, so as for the fixing segment and the corresponding fixing segment to stop each other, allowing the joining segment and the shaft segment to be fitted together.

The fastening structure further comprises an electrically conducting segment for transmitting an electrical current to electrically drive the baffle to operate.

The fastening structure further comprises a body segment and a wheel component, with the joining segment disposed at the body segment, and the anti-rotation segment disposed at the joining segment or the body segment, or the wheel component and an shaft segment disposed at the body segment, or the body segment having an alignment segment parallel to a side of the wheel component, or the alignment segment being adapted to correct an advancing direction of the wheel component, prevent an end portion of the wheel component from interfering with the body segment to the detriment of its rolling, or prevent an end portion of the wheel component from tilting and interfering with the body segment to the detriment of its rolling.

Therefore, a fastening structure of the present disclosure enables at least two objects to be firmly fitted together.

### BRIEF DESCRIPTION OF THE DRAWINGS

FIG. 1 is a schematic perspective view of a fastening structure according to an embodiment of the present disclosure.

FIG. 2 is a schematic view of the fastening structure according to an embodiment of the present disclosure.

FIG. 3 is a schematic cross-sectional view of the fastening structure according to an embodiment of the present disclosure.

FIG. 4 is a schematic cross-sectional view of the fastening structure according to an embodiment of the present disclosure.

FIG. 5 is a schematic cross-sectional view of the fastening structure according to an embodiment of the present disclosure.

FIG. 6 is a schematic cross-sectional view of the fastening structure according to an embodiment of the present disclosure.

FIG. 7 is a schematic view of the fastening structure according to an embodiment of the present disclosure.

FIG. 8 is a schematic view of the fastening structure according to an embodiment of the present disclosure.

FIG. 9 is a schematic top view of the fastening structure according to an embodiment of the present disclosure.

FIG. 10 is a schematic view of the fastening structure according to an embodiment of the present disclosure.

FIG. 11 is a schematic view of the fastening structure according to an embodiment of the present disclosure.

FIG. 12 is a schematic view of the fastening structure according to an embodiment of the present disclosure.

FIG. 13 is a schematic view of the fastening structure according to an embodiment of the present disclosure.

FIG. 14 is a schematic view of the fastening structure according to an embodiment of the present disclosure.

FIG. 15 is a schematic view of the fastening structure according to an embodiment of the present disclosure.

FIG. 16 is a schematic view of the fastening structure according to an embodiment of the present disclosure.

FIG. 17 is a schematic view of the fastening structure according to an embodiment of the present disclosure.

FIG. 18 is a schematic view of the fastening structure according to an embodiment of the present disclosure.

FIG. 19 is a schematic side view of the fastening structure according to an embodiment of the present disclosure.

FIG. 20 is a schematic view of the fastening structure according to an embodiment of the present disclosure.

FIG. 21 is a schematic view of the fastening structure according to an embodiment of the present disclosure.

FIG. 22 is a schematic view of the fastening structure according to an embodiment of the present disclosure.

FIG. 23 is a schematic view of the fastening structure according to an embodiment of the present disclosure.

FIG. 24 is a schematic view of the fastening structure according to an embodiment of the present disclosure.

FIG. 25 is a schematic view of the fastening structure according to an embodiment of the present disclosure.

FIG. 26 is a schematic view of the fastening structure according to an embodiment of the present disclosure.

FIG. 27 is a schematic view of the fastening structure according to an embodiment of the present disclosure.

FIG. 28 is a schematic view of the fastening structure according to an embodiment of the present disclosure.

FIG. 29 is a schematic view of the fastening structure according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

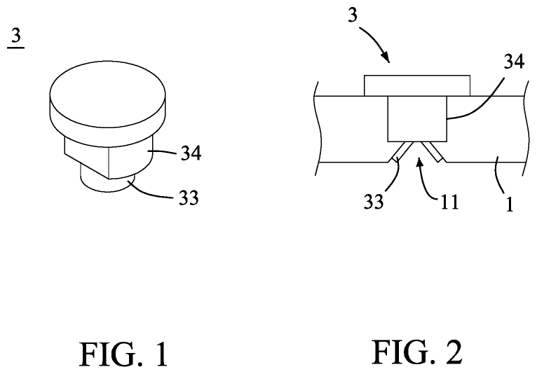

Referring to FIG. 1 and FIG. 2, the disclosure provides a fastening structure 3, applicable to a first object 1 and a second object 2. The fastening structure 3 comprises an anti-rotation segment 34 and a joining segment 33.

The anti-rotation segment 34 prevents the fastening structure 3 from rotating relative to the first object 1.

The joining segment 33 is fitted to the first object 1. The joining segment 33 is a fastening segment 31, a riveting portion, an expanded connection portion, a welding portion, a locking portion, or a resilient fastener segment.

In an embodiment, the joining segment 33 is adapted to be fitted to the first object 1 by expanded connection. The joining segment 33 functions as an expanded connection portion, and the first object 1 has an expansion aperture 11. Referring to FIG. 1 and FIG. 2, the fastening structure 3 is prevented by the anti-rotation segment 34 from rotating relative to the first object 1 and then expandedly connected to the expansion aperture 11 of the first object 1 by the joining segment 33 functioning as an expanded connection portion.

In an embodiment, the anti-rotation segment 34 is a flat surface portion, step portion, knurled portion, inclined surface portion, dented portion, raised portion, arcuate surface, or curved surface.

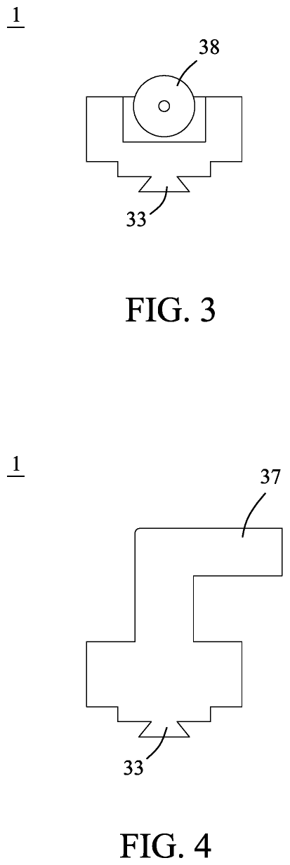

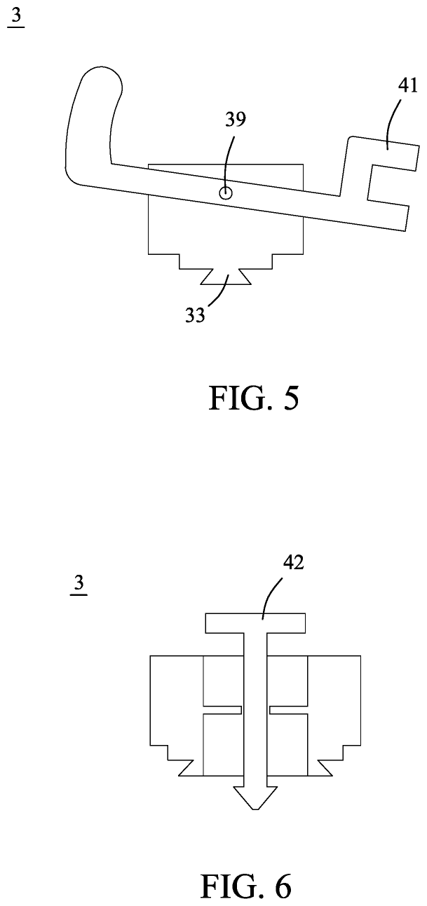

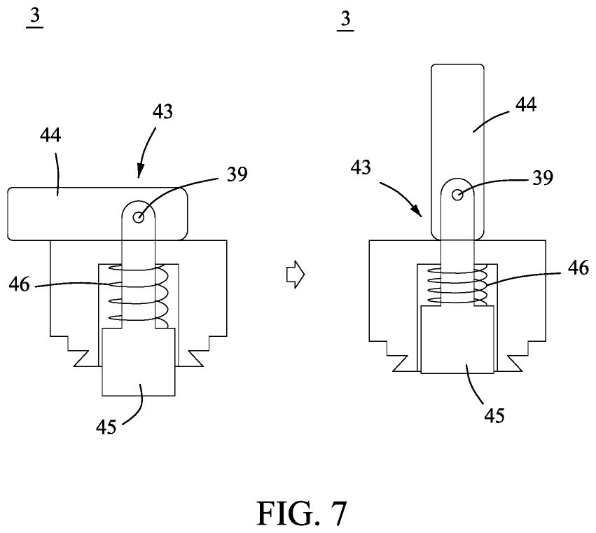

Referring to FIG. 3 through FIG. 7, the fastening structure 3 not only comprises the joining segment 33 being the fastening segment 31 but also comprises a handle segment 37 (as shown in FIG. 4). Alternatively, the fastening structure 3 has a shaft segment 39 and a wheel component 38 connected to the rotating shaft segment 39 (as shown in FIG. 3). Alternatively, the fastening structure 3 has an assisting component 41 mounted on the shaft segment 39 (as shown in FIG. 5). Alternatively, an another fastener body 42 (as shown in FIG. 6) is penetratingly disposed at the fastening structure 3 to engage with another object (not shown). Alternatively, as shown in FIG. 7, the fastening structure 3 has another fastening element 43 with a rotational body 44. The another fastening element 43 comprises the rotational body 44 and a fastener body segment 45 pivotally connected to the rotational body 44. The rotational body 44 is disposed on the top surface of the fastening structure 3. The fastener body segment 45 is disposed in the fastening structure 3 and adapted to protrude from or retract into the fastening structure 3 as a result of the operation of the rotational body 44 in order to engage with the another object.

A fastening body elastic element 46 is abuttingly disposed between the fastener body segment 45 and the fastening structure 3 to allow the fastener body segment 45 to spring up as soon as the rotational body 44 is rotated to a predetermined angle; however, the disclosure is not limited thereto, as the joining segment 33 is the fastening segment 31.

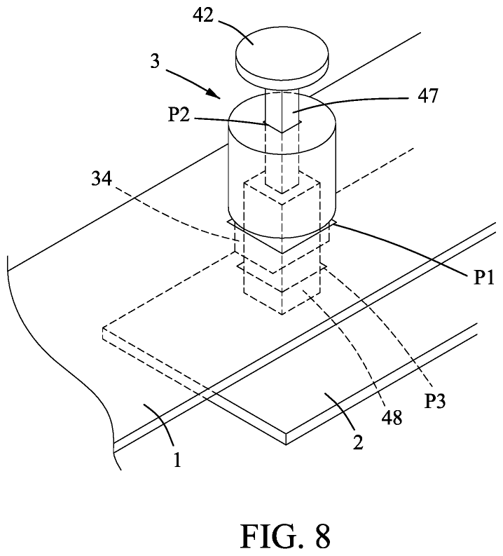

Referring to FIG. 8, the another fastener body 42 has an another fastener body anti-rotation segment 47 and another anti-rotation segment 48 for allowing the fastening structure 3 and the other object (for example, the second object 2 to constrain each other or prevent each other from rotating, but the disclosure is not limited thereto. Alternatively, the another fastener body 42 has the fastening body anti-rotation segment 47 only, allowing the fastening body anti-rotation segment 47 and the fastening structure 3 to constrain each other or prevent each other from rotating. Alternatively, the another fastener body 42 has the another anti-rotation segment 48 only, allowing the another anti-rotation segment 48 and the other object to constrain each other or prevent each other from rotating.

The first object 1 has a first corresponding anti-rotation segment P1, allowing the first corresponding anti-rotation segment P1 and the anti-rotation segment 34 to prevent each other from rotating. The fastening structure 3 has a second corresponding anti-rotation segment P2, allowing the second corresponding anti-rotation segment P2 and the fastening body anti-rotation segment 47 to prevent each other from rotating. The second object 2 has a third corresponding anti-rotation segment P3, allowing the third corresponding anti-rotation segment P3 and the another anti-rotation segment 48 to prevent each other from rotating. The anti-rotation segment 34, the fastening body anti-rotation segment 47 and the another anti-rotation segment 48 are solids in a non-round shape, for example, in a polygonal shape. The first corresponding anti-rotation segment P1, the second corresponding anti-rotation segment P2, and the third corresponding anti-rotation segment P3 are openings or through-holes in corresponding, non-round shapes.

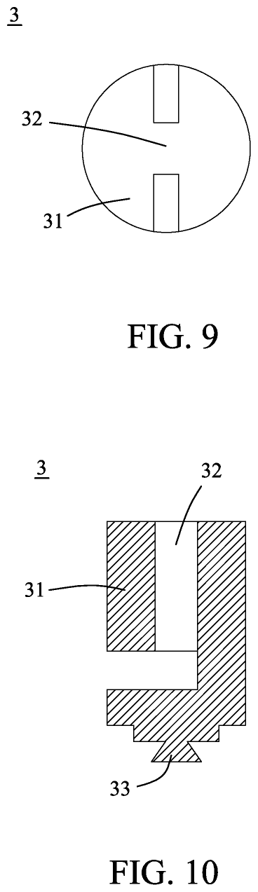

Referring to FIG. 9 and FIG. 10, a directional restriction segment 32 of the fastening structure 3 limits the angle between the movement direction of the second object 2 and the joining segment 33. In this embodiment, the limitation is placed to ensure that the movement direction of the second object 2 is perpendicular to the joining segment 33. Alternatively, the limitation is placed such that the movement direction of the second object 2 is parallel to the joining segment 33 or neither parallel nor perpendicular to the joining segment 33.

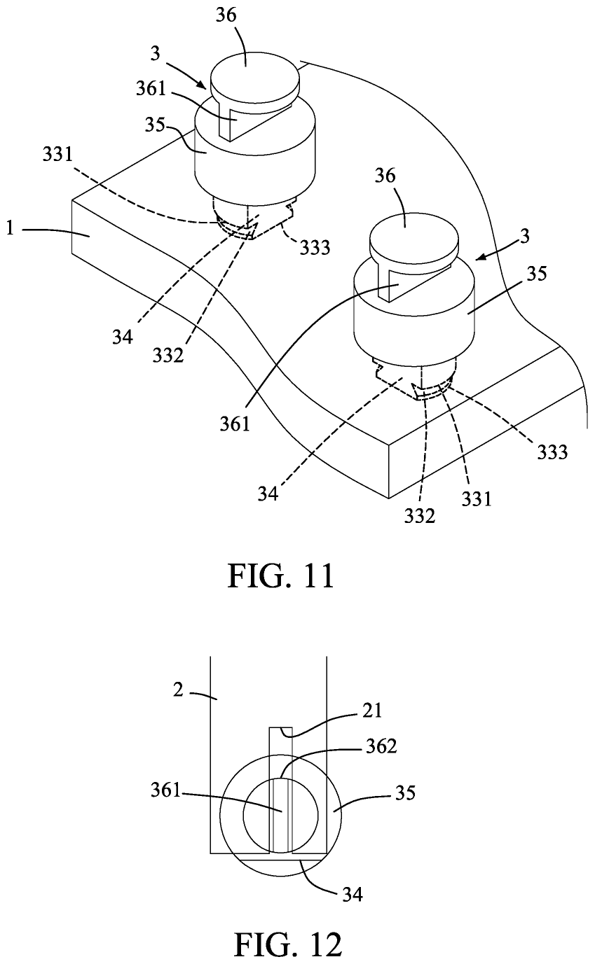

The embodiment illustrated by FIG. 11 and FIG. 12 is distinguished from the preceding embodiments by technical features described below. In the embodiment illustrated by FIG. 11 and FIG. 12, the fastening structure 3 further comprises a body segment 35, and the joining segment 33 is disposed at a bottom of the body segment 35, allowing the anti-rotation segment 34 to be disposed on one side of the joining segment 33. The fastening structure 3 further comprises a fastener segment 36 with a neck segment 361, and the neck segment 361 has a limiting segment 362 for limiting an engagement direction of a corresponding limiting segment 21 of the second object 2, allowing the fastener segment 36 to meet the requirements of practical application.

The neck segment 361 of the fastener segment 36 limits an engagement direction of a second object 2. When the fastening structure 3 is disposed at the first object 1, not only does the anti-rotation segment 34 limit directions of the fastening structure 3 and the fastener segment 36, but the neck segment 361 also limits the engagement direction of the second object 2, allowing the fastener segment 36 to meet the requirements of practical application.

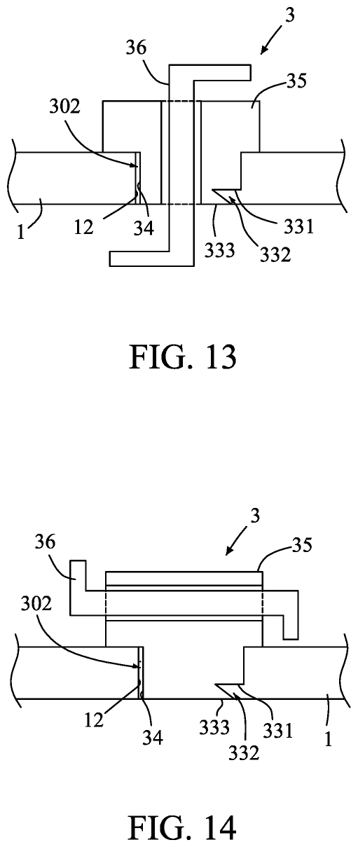

The embodiment illustrated by FIG. 13 and FIG. 14 is distinguished from the preceding embodiments by technical features described below. In the embodiment illustrated by FIG. 13 and FIG. 14, the joining segment 33 has a pressing segment 331, a material holding space 332 and a limiting segment 333. The pressing segment 331 presses the first object 1 such that the material of the first object 1 flows into or enters the material holding space. The limiting segment 333 confines the fastening structure 3 to the first object 1. The anti-rotation segment 34 limits a limiting direction of the fastening structure 3.

During the assembly process, the anti-rotation segment 34 of the fastening structure 3 and a corresponding stopper segment 301 of a second mold 30 correspond in position to each other to stop each other. The first object 1 is positioned at a pressing position of the fastening structure 3. The anti-rotation segment 34 corresponds in position to a corresponding stopper segment 12 of the first object 1. The first mold 20 presses on the body segment 35 of the fastening structure 3 under an external force such that the material of the first object 1 flows into or enters the material holding space 332. The limiting segment 333 constrains the first object 1. The corresponding stopper segment 12 and the anti-rotation segment 34 correspond in position to each other to stop each other. The anti-rotation segment 34 limits the direction of the fastening structure 3, allowing the disclosure to meet the requirements of practical application.

Unlike the preceding embodiments of the disclosure, an embodiment of the present disclosure exhibits distinguishing technical features described below. The fastener segment 36 is movably positioned at the body segment 35. When the pressing segment 331 of the fastening structure 3 is positioned at the first object 1, a compression gap 302 is formed between the corresponding stopper segment 12 of the first object 1 and the anti-rotation segment 34 of the fastening structure 3. Thus, it is easy for the pressing segment 331 of the fastening structure 3 to be positioned at a pressing position of the first object 1.

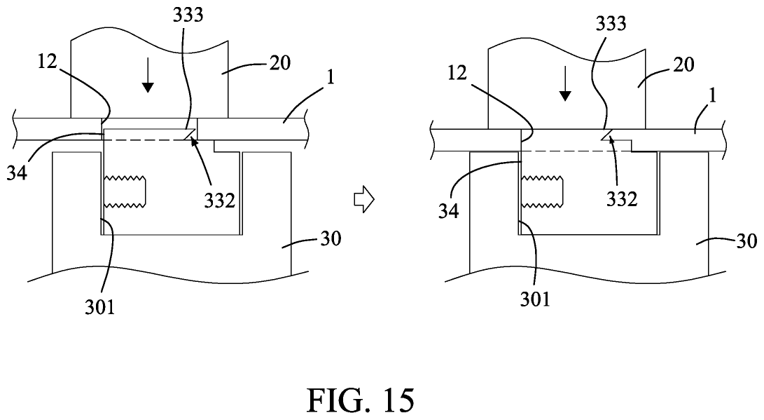

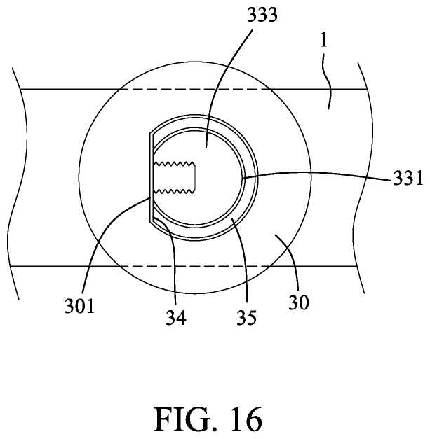

The embodiment illustrated by FIG. 15 and FIG. 16 is distinguished from the preceding embodiments by technical features described below. In the embodiment illustrated by FIG. 15 and FIG. 16, the anti-rotation segment 34 and the corresponding stopper segment 301 of the second mold 30 correspond in position to each other to stop each other, allowing the anti-rotation segment 34 to limit a limiting direction of the fastening structure 3.

During the assembly process, the anti-rotation segment 34 of the fastening structure 3 and the corresponding stopper segment 301 of the second mold 30 correspond in position to each other to stop each other, the first object 1 is positioned at a pressing position of the fastening structure 3, the anti-rotation segment 34 is positioned at the corresponding stopper segment 12 of the first object 1, the first mold 20 presses on the body segment 35 of the fastening structure 3 under an external force such that the material of the first object 1 flows into or enters the material holding space 332, the limiting portion 333 constrains the first object 1, the corresponding stopper segment 12 and the anti-rotation segment 34 correspond in position to each other to stop each other, and the anti-rotation segment 34 limits the direction of the fastening structure 3, allowing the present disclosure to meet the requirements of practical application.

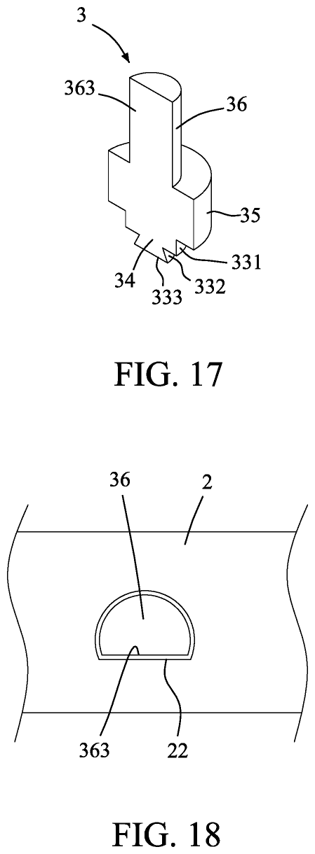

In the embodiment illustrated by FIG. 17 and FIG. 18, the fastening structure 3 further comprises a fastener segment 36 with an anti-rotation segment 363. The anti-rotation segment 363 limits a rotation prevention direction or an engagement direction of a corresponding anti-rotation segment 22 of the second object 2, allowing the present disclosure to meet the requirements of practical application.

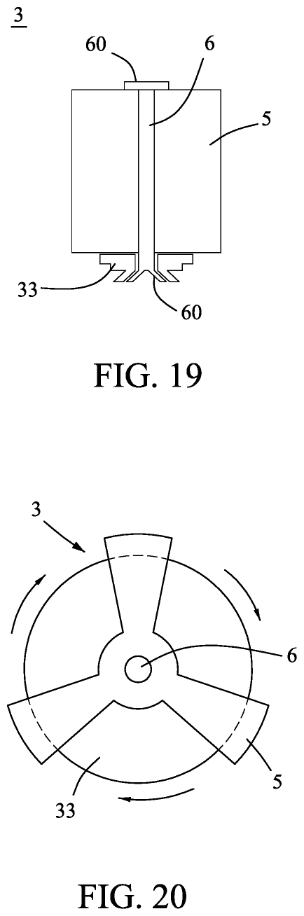

In the embodiment illustrated by FIG. 19, the fastening structure 3 further comprises a baffle 5 and a shaft segment 6. The shaft segment 6 is disposed at the joining segment 33. The baffle 5 is disposed at the shaft segment 6. The baffle 5 blocks or guides a fluid.

To start using the fastening structure 3, the joining segment 33 of the fastening structure 3 is fitted to the first object 1 such that the fastening structure 3 is firmly fitted to the first object 1. With the shaft segment 6, it is feasible for the baffle 5 to be configured to be stationary or movable. In this embodiment, the baffle 5 is movably disposed at the shaft segment 6, and an air-cooled apparatus on the first object 1 generates an air current (or a liquid-cooled apparatus on the first object 1 generates a liquid flow) to be guided to the baffle 5, such that the baffle 5 can change a direction of a fluid by blocking-style guidance or rotating-style guidance to guide the fluid to a position of heat generation or a required heat dissipation position to achieve heat dissipation with the fluid, allowing the baffle 5 to effectively guide or stir the fluid in order for heat dissipation to take place.

In an embodiment of the present disclosure, a blocking segment 60 is disposed at one end or two ends of the shaft segment 6 each and stopped at the baffle 5 or the joining segment 33. In this embodiment, a blocking segment 60 is disposed at each of the two ends of the shaft segment 6, and the blocking segments 60 are stopped at the baffle 5 and the joining segment 33, respectively, allowing the baffle 5 and the joining segment 33 to be firmly mounted on the shaft segment 6.

The embodiment illustrated by FIG. 20 is distinguished from the preceding embodiments by technical features described below. In the embodiment illustrated by FIG. 20, the baffle 5 is sheet-shaped, fanlike, movable/rotational, and capable of blocking or rotating a fluid to change a movement direction thereof, to guide the fluid to a position of heat generation or a required heat dissipation position to achieve heat dissipation with the fluid, allowing the baffle 5 to effectively guide or stir the fluid in order for heat dissipation to take place.

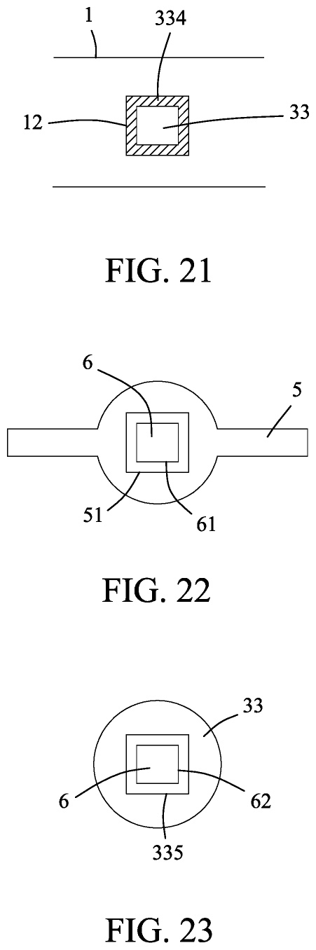

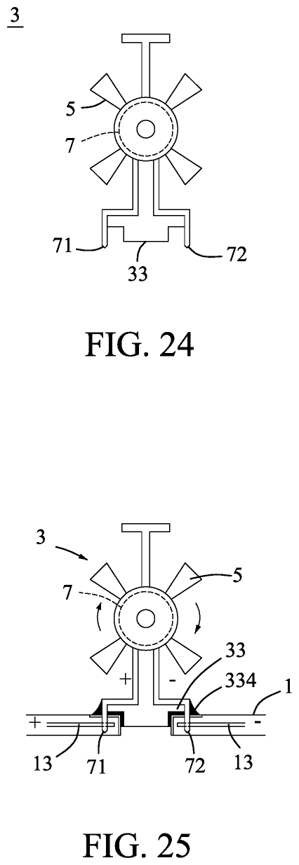

The embodiment illustrated by FIG. 21 is distinguished from the preceding embodiments by technical features described below. In the embodiment illustrated by FIG. 21, the joining segment 33 has a tin layer 334 curable when cooled down after being heated up and capable of allowing the fastening structure 3 to be soldered or welded to the corresponding stopper segment 12 of the first object 1 such that the fastening structure 3 is firmly fitted to the first object 1, allowing the present disclosure to meet the requirements of practical assembly.

The embodiment illustrated by FIG. 22 is distinguished from the preceding embodiments by technical features described below. In the embodiment illustrated by FIG. 22, the shaft segment 6 has a limiting segment 61, and the baffle 5 has a corresponding limiting segment 51, so as for the limiting segment 61 and the corresponding limiting segment 51 to jointly limit a direction or an angle of the baffle 5 and thereby enable the baffle 5 to be fitted to the shaft segment 6 in a specific direction or at a specific angle, allowing the disclosure to meet the requirements of practical assembly.

The embodiment illustrated by FIG. 23 is distinguished from the preceding embodiments by technical features described below. In the embodiment illustrated by FIG. 23, the shaft segment 6 has a fixing segment 62, and the joining segment 33 has a corresponding fixing segment 335. The fixing segment 62 and the corresponding fixing segment 335 stop each other such that the joining segment 33 and the shaft segment 6 are fitted together firmly, allowing the present disclosure to meet the requirements of practical assembly.

In the embodiment illustrated by 24 and FIG. 25, the fastening structure 3 further comprises a conducting segment 7 for transmitting an electrical current to electrically drive the baffle 5 to operate.

In an embodiment of the present disclosure, the conducting segment 7 is disposed at the joining segment 33, and the baffle 5 is a blade disposed at the conducting segment 7. The conducting segment 7 has a positive terminal 71 and a negative terminal 72. The first object 1 is a printed circuit board. The first object 1 has a corresponding conducting segment 13. The positive terminal 71 and the negative terminal 72 are connected to the corresponding conducting segment 13 to supply the electric power required for the operation of the conducting segment 7 when an electronic apparatus is operating in conjunction with the first object 1.

To start using the fastening structure 3, a tin layer 334 of the joining segment 33 of the fastening structure 3 is soldered or welded to the first object 1 to not only allow the joining segment 33 of the fastening structure 3 to be firmly fitted to the first object 1 but also allow the conducting segment 7 to drive the baffle 5 to rotate (or move) such that the conducting segment 7 and the baffle 5 jointly generate an air flow to guide the fluid to a position of heat generation or a required heat dissipation position to achieve heat dissipation with the fluid, allowing the baffle 5 to effectively guide or stir the fluid in order for heat dissipation to take place.

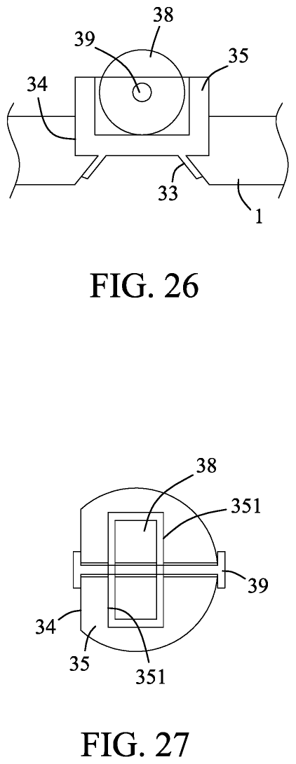

The embodiment illustrated by FIG. 26 and FIG. 27 is distinguished from the preceding embodiments by technical features described below. In the embodiment illustrated by FIG. 26 and FIG. 27, the fastening structure 3 further comprises a body segment 35 and a wheel component 38. The joining segment 33 is positioned at the body segment 35. The anti-rotation segment 34 is positioned at the body segment 35 (or the joining segment 33). The wheel component 38 and the shaft segment 39 are pivotally connected and disposed at the body segment 35. The body segment 35 has an alignment segment 351 parallel to one side of the wheel component 38. The alignment segment 351 corrects an advancing direction of the wheel component 38, prevents an end portion of the wheel component 38 from interfering with the body segment 35 to the detriment of its rolling, or prevents an end portion of the wheel component 38 from tilting and interfering with the body segment 35 to the detriment of its rolling.

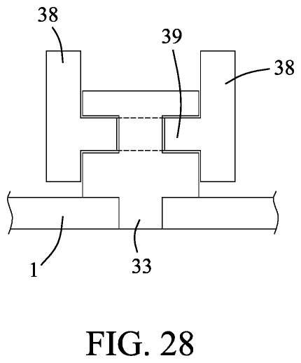

As seen in FIG. 28, in an embodiment of the present invention, a distinction from the aforementioned embodiments lies in the quantity of wheel components 38, for example, totals two. These wheel components 38 are linked by the shaft segment 39, and the shaft segment 39 is pivotally set within the body segment 35, allowing the wheel components 38 to be mobile on both sides of the body segment 35. The ends of these wheel components 38 are positioned higher than the body segment 35, ensuring that the ends of the wheel components 38 do not interfere with or affect the rolling of the body segment 35.

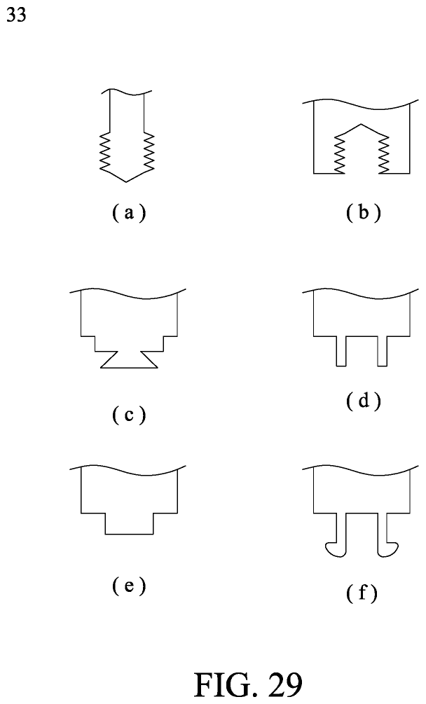

As depicted in FIG. 29, in an embodiment of the present invention, a distinction from the aforementioned embodiments lies in the fact that joining segment 33 can take various forms, such as external threads (as illustrated in part ‘a’ of FIG. 29), internal threads (part ‘b’ of FIG. 29), riveting (part ‘c’ of FIG. 29), expanding sections (part ‘d’ of FIG. 29), welding sections (part ‘e’ of FIG. 29), or snap-fit sections (part ‘f’ of FIG. 29). This allows the selection of different types of joining segments 33 according to the specific assembly requirements, ensuring a secure integration of fastening structure 3 with the first object 1, thus aligning with practical assembly needs.

The present invention is disclosed above by preferred embodiments. However, the embodiments are illustrative of the invention only, but shall not be interpreted as restrictive of the scope of the invention. It is noteworthy that all equivalent replacements and changes made to the embodiments shall fall within the scope of the invention. Therefore, the legal protection for the invention shall be defined by the appended claims.

What is claimed is:

1. A fastening structure, applicable to a first object, the fastening structure comprising:
an anti-rotation segment for preventing the fastening structure from rotating relative to the first object; and
a joining segment adapted to be fitted to the first object, the joining segment being a fastening segment, a riveting portion, an expanded connection portion, a soldering portion, a welding portion, a locking portion, or a resilient fastener segment.

2. The fastening structure of claim 1, further comprising the fastening segment and a directional restriction segment, the fastening segment being snap-engaged with a second object, and the directional restriction segment being connected to the fastening segment to limit a movement direction of the second object snap-engaged with the fastening segment.

3. The fastening structure of claim 1, wherein the anti-rotation segment and the first object prevent each other from rotating, allowing the anti-rotation segment to be expandedly connected to the first object by an expansion aperture, or wherein the fastening structure has another fastener body having an another fastener body anti-rotation segment, allowing the another fastener body anti-rotation segment and the fastening structure to constrain each other or prevent each other from rotating, or wherein the fastening structure has another fastener body having another anti-rotation segment, allowing the another anti-rotation segment and another object to constrain each other or prevent each other from rotating, or further comprising a joining segment being the fastening segment, or the fastening structure having a handle segment, or the fastening structure having a wheel component, an assisting component, an another fastener body, or an another fastening structure with a rotational body, or the joining segment being a fastening segment, or further comprising a body segment, with the joining segment being disposed at the body segment, the anti-rotation segment being positioned at the joining segment or the body segment, or the joining segment having a pressing segment, a material holding space and a restriction segment, the pressing segment pressing the first object, allowing a material of the first object to flow into or enter the material holding space, with the restriction segment confining the fastening structure to the first object, and the anti-rotation segment limiting a limiting direction of the fastening structure, or the fastening structure further comprising a fastener segment with a neck segment, the neck segment having a limiting segment for limiting an engagement direction of a corresponding limiting segment of a snap-engagement object, or the fastening structure further comprises a fastener segment with a neck segment for limiting a pair of fastener segments, or the fastening structure further comprising a fastener segment with a limiting segment for limiting an engagement direction of a corresponding limiting segment of a snap-engagement object, or the fastening structure further comprising a fastener segment, the fastener segment being movably positioned at the body segment.

4. The fastening structure of claim 1, further comprising a directional restriction segment for limiting an angle between a movement direction of the second object and a joining segment such that the movement direction of the second object is parallel to, perpendicular to, or neither parallel nor perpendicular to the joining segment.

5. The fastening structure of claim 1, wherein the first object has a corresponding stopper segment, and a compression gap is formed between the corresponding stopper segment and the anti-rotation segment.

6. The fastening structure of claim 1, wherein the anti-rotation segment and a corresponding stopper segment of a mold correspond in position to each other to stop each other, allowing the anti-rotation segment to limit a limiting direction of the fastening structure.

7. The fastening structure of claim 1, wherein the fastening structure further comprising a fastener segment, with the anti-rotation segment positioned at the fastener segment and adapted to limit a rotation prevention direction or an engagement direction of a corresponding anti-rotation segment of a snap-engagement object.

8. The fastening structure of claim 1, wherein the anti-rotation segment is a flat surface portion, step portion, knurled portion, inclined surface portion, dented portion, raised portion, arcuate surface, or curved surface.

9. The fastening structure of claim 1, further comprising a baffle and an shaft segment, with the shaft segment disposed at the joining segment, and the baffle disposed at the shaft segment and adapted to block or guide a fluid, or the baffle movably disposed at the shaft segment, or the baffle being sheet-shaped or fanlike, or the shaft segment having a limiting segment, the baffle having a corresponding limiting segment, allowing the limiting segment and the corresponding limiting segment to jointly limit a direction or an angle of the baffle, or the shaft segment having a fixing segment, the joining segment having a corresponding fixing segment, so as for the fixing segment and the corresponding fixing segment to stop each other, allowing the joining segment and the shaft segment to be fitted together, or further comprising a conducting segment for transmitting an electrical current to electrically drive the baffle to operate.

10. The fastening structure of claim 1, wherein the joining segment has a tin layer curable when cooled down after being heated up and capable of allowing the fastening structure to be soldered or welded to the first object.

11. The fastening structure of claim 1, further comprising a body segment and a wheel component, with the joining segment disposed at the body segment, and the anti-rotation segment disposed at the joining segment or the body segment, or the wheel component and a shaft segment disposed at the body segment, or the body segment having an alignment segment parallel to a side of the wheel component, or the alignment segment being adapted to correct an advancing direction of the wheel component, prevent an end portion of the wheel component from interfering with the body segment to the detriment of its rolling, or prevent the end portion of the wheel component from tilting and interfering with the body segment to the detriment of its rolling.
